(19) United States
(12) Patent Application Publication
(10) Pub. No.: US 2005/0127564 A1
(43) Pub. Date: Jun. 16, 2005

(54) Method and device for producing a composite product, and composite product produced therewith

(75) Inventors: Hendrikus Christianus Engelbertus Van Der Aa, AC Haarlem (NL); Anthony Stephan Verdier, Heemskerk (NL); Hugo Gerrit Jan De Wolf, Haarlem (NL)

Correspondence Address: STEVENS DAVIS MILLER & MOSHER, LLP, 1615 L STREET, NW, SUITE 850, WASHINGTON, DC, 20036, US

(73) Assignee: Corus Technology, CA Ijmuiden (NL)

(21) Appl. No.: 10/500,706

(22) PCT Filed: Jan. 10, 2003
(86) PCT No.: PCT/NL03/00016

(30) Foreign Application Priority Data
Jan. 11, 2002 (NL) 1019729

(51) Int. Cl. B29C 45/14

(52) U.S. Cl. 264/266; 425/125; 425/127; 425/129.1

(57) ABSTRACT

A method for producing a composite product including a plastic body and a covering layer formed from a metal blank which at least over part of its surface is stuck to the plastic body, wherein—the metal blank is placed in a die, which die includes a blank holder, a mandrel which can move with respect to the blank holder, and a support die,—the die is closed, so the support die and the mandrel are located on either side of the metal blank, and the metal blank is supported in the vicinity of its edge with the aid of the blank holder,—a liquid plastic is injected into the die, the liquid plastic being brought into contact with the metal blank,—the liquid plastic being converted into a solid plastic body stuck to the metal blank to produce the composite product,—the composite product is removed from the die.

The invention relates to a method for producing a composite product comprising a plastic body and a covering layer formed from a metal blank which at least over part of its surface is stuck to the plastic body. The invention also relates to a device for producing a composite product which comprises a plastic body and a covering layer formed from a metal blank, which covering layer, at least over part of its surface, is stuck to the plastic body, and to a composite product of this type.

A product of this type is known from German Patent DE 41 23 766 C. The known product, which is a door case, comprises a hollowly shaped metal covering layer, the hollow shape of which is filled with an injection-molded plastic body, which plastic is stuck to the covering layer. This door case is obtained by placing a metal sheet in an injection mold and imparting the desired shape to the metal sheet in the injection mold under the injecting-molding pressure and also providing the sheet with a plastic body.

A drawback associated with the product described above is that its entire cavity is filled with the injection-molded plastic body.

It is an object of the invention to provide a method and device for producing a composite product in which it is not necessary to fill the entire cavity in the metal covering layer with the plastic body.

It is another object of the invention to provide a method and device which allow flexible production of a composite product.

It is yet another object of the invention to provide a method and device which allows simple, rapid and economic production of a composite product.

It is also an object of the invention to produce a composite product of this type.

According to the invention, one or more of these objects is achieved by a method for producing a composite product comprising a plastic body and a covering layer formed from a metal blank which at least over part of its surface is stuck to the plastic body, wherein

the metal blank is placed in a die, which die comprises a blank holder, a mandrel which can move with respect to the blank holder, and a support die,

the die is closed, so that the support die and the mandrel are located on either side of the metal blank, and the metal blank is supported in the vicinity of its edge with the aid of the blank holder,

a liquid plastic is injected into the die, the liquid plastic being brought into contact with the preformed metal blank,

the liquid plastic being converted into a solid plastic body which is stuck to the preformed metal blank in order to produce the composite product,

the composite product is removed from the die.

This creates a method in which a preformed metal blank is not necessarily completely filled with the plastic body. This is achieved with a preformed metal blank in which a cavity has been formed in the preformed metal blank, and during the injection of the liquid plastic, the cavity which has been formed can be partly filled with the mandrel, with the result that there is less space available for the liquid plastic to be injected into. The thickness of the plastic body is then thinner than the depth of the cavity which has been formed with the aid of the mandrel, so that the final composite product can also be hollow.

As a result of the liquid plastic being injected into the die, the liquid plastic takes up all the available space without the volume having to be reduced with the aid of the mandrel for this purpose.

According to the invention, it is also possible for the plastic body to be applied to the metal covering layer on its side which has not been processed using the mandrel.

In addition, with the method according to the invention it is also possible to use a non-preformed, flat blank, to which a layer of plastic is applied in the form of a recess in the mandrel. In this case, the mandrel has to be able to move in relative terms with respect to the blank holder in order for it to be possible for the edge of the mandrel to be pressed onto the blank.

It should be noted that EP-A 0 186 015 proposes a method in which a certain quantity of plastic is introduced between mandrel and preformed metal blank and in which the blank is only converted into its final form, by plastic deformation, after the plastic has been introduced, as a result of the distance between mandrel and support die being reduced further. In the present invention, the pressure required is supplied by injection of the plastic into the die, preferably by injection molding, with the result that it is not necessary for the mandrel and support die to be moved towards one another during the supply of the plastic or after the plastic has been supplied.

According to a preferred embodiment of the method, the metal blank is supported in the blank holder in the vicinity of its edge, and the metal blank, after the die has been closed and before the liquid plastic is injected, is mechanically preformed with the aid of the mandrel, the mandrel being moved in relative motion along the blank holder toward the support die. The advantage of this embodiment of the method is that it is possible, starting from a flat blank, to make a composite product having a preformed metal covering layer and a plastic body stuck to it in a single die.

The fact that it is now possible for the mandrel and support die to be moved apart if desired during the injection of the liquid plastic means that the freedom available in terms of shaping the composite product in production is increased. Therefore, it is preferable for the liquid plastic to be injected into the die under pressure, with the entire space available being filled by the liquid plastic.

For example, in the method according to the invention, the liquid plastic does not have to be kept workable or liquid for such a long time in the die as if it were only shaped and/or molded as a result of the reduction in the volume available.

In one embodiment of the method, the liquid plastic is injected into the die under pressure, during which process the metal blank is deformed further. In this way, it is possible to impart certain complicated and/or detailed shapes and/or reliefs to the metal blank, such as embossing and sharp angles.

In one embodiment of the method, the liquid plastic is injected into the die at a pressure of at least 200 bar and at most 4000 bar, preferably at least 400 bar, more preferably at least 800 bar and even more preferably at least 1200 bar. The higher the pressure is selected to be, the stronger and smoother the adhesion of the plastic body to the metal blank has proven to be. Therefore, it is possible to attach a thinner plastic body if desired.

For the same reasons, the liquid plastic can be injected into the die at a liquid plastic flow rate of at least 10 cm³/s, preferably of at least 20 cm³/s, if appropriate in combination with the pressures described. A flow rate above these limits further enhances the possibilities for the liquid plastic no longer having to be kept in liquid or workable form in the die.

In one embodiment of the method, during the preforming of the metal blank, the metal blank is clamped between the mandrel and the support die and the support die is moved with the mandrel. The result of this is that the edges of the metal blank are formed neatly, or at any rate controllably, around the mandrel.

In one embodiment of the method, before or during the injection of the liquid plastic, the mandrel and the support die are moved away from one another. This results in the formation of a space in the die into which the plastic body can be molded.

In one embodiment, during the injection of the liquid plastic, the plastic is also brought into contact with an end edge of the preformed metal blank. This results in a neat finishing of the metal covering layer. This is advantageous in particular if the metal covering layer has a less than negligible thickness. Another advantage is that the end side of the metal blank is protected against corrosion by the plastic body.

In one embodiment of the method, the metal blank, at least during the preforming, is held in a grip, which is closed by spring force, of a holding-down clamp which is present in the blank holder. As a result, the deformability of the metal blank is utilized better, since the preforming of the metal blank is not limited to simple molding, but rather may also encompass deep-drawing. The spring force can be selected in such a manner that sufficient flow of metal occurs under the grip of the holding-down clamp to prevent the material from cracking under the influence of the relative movement of the mandrel while at the same time the risk of wrinkling is minimized.

In a particular embodiment, in which the preformed metal blank is deformed further under the influence of the pressure and in which a holding-down clamp is present in the blank holder, the metal blank, at least during the injection of the liquid plastic, is held in a grip, which is closed by spring force, of the holding-down clamp. The result of this is that the deformability is also utilized better during the further deformation of the metal blank. The preformed metal blank can in this way, under the influence of the liquid plastic, be, as it were, deep-drawn further.

Partly to ensure that the end edge of the metal blank can also be covered by the plastic body, it is preferable in this case for the spring force to be selected in such a manner that the metal blank is pulled out of the grip of the holding-down clamp and in the process experiences a certain resistance.

In one embodiment, while the die is being closed, the support die is pushed into a cutting frame. Parts of the blank which extend over the cutting frame are in this way cut off while the die is being closed. The result of this is that the blank is always in the correct dimensions. It is preferable for the blank to be cut in this way before the blank is mechanically preformed by the mandrel.

After the liquid plastic has been injected into the die, additional material can be injected into the die in at least one after-molding step. This prevents and/or compensates for possible shrinkage of the solidified plastic on the surface of the metal blank. Moreover, this measure produces a pleasingly taut and smooth surface.

According to the invention, the metal blank can, for example, be selected from a group of types of metal consisting of steel, stainless steel, galvanized steel, tin-plated steel, chrome-plated steel, copper-plated steel, Ni-coated steel, aluminum, alloys based on aluminum, copper, brass, bronze, silver, gold, titanium.

According to the invention, the plastic may, for example, be selected from a group of types of plastic consisting of PP, PET, PE, ABS, PMMA, SAN, PC, PA, PU, PUR, SAN and copolymers thereof, if desired, filled with a pulverulent filler, such as ceramic and/or metallic particles, or filled with foaming agents. After the die has been opened, the plastic coating layer can be foamed with the aid of the foaming agents, for example in order to fill a shaped cavity in the metal blank.

With the aid of the method according to the invention, it is possible for the metal blank to be cut under the influence of the pressure with which the liquid plastic is injected into the die. That section of the blank which has been cut out is connected to the remainder of the composite product with the aid of the plastic body.

In one embodiment of the method, the metal blank is provided with a plastic coating layer, which can preferably be fused to the injected plastic, such as PET, PP or holographic material. If the liquid plastic is injected into the die in the molten state, it is possible, for example, by fusing the plastic coating layer to the injected plastic, to obtain good bonding between the plastic body and the metal covering layer. Single-sided coating may be sufficient, but it will be clear to the person skilled in the art that a metal blank which is coated on both sides can also be used.

Moreover, the plastic coating layer protects the die and the optional holding-down clamp from damage which could be caused by an uncoated metal blank. For this purpose, it is preferable to use a metal blank which is coated on both sides.

If the metal blank has been provided with a plastic coating layer, it is particularly advantageous if, as has already been described above, the injection of the liquid plastic is continued after the metal blank has been completely pulled out of the grip of the holding-down clamp. One problem with using a holding-down clamp when forming plastic-coated steel is the formation of hairs. This problem is described, for example, in EP 0 536 952 A1. Hairs which form in the vicinity of the end edge of the metal blank through interaction with the grip of the holding-down clamp, according to the present embodiment of the invention are fused to the liquid plastic and/or processed in such a manner as to become virtually invisible. As a result, the negative consequences of the formation of hairs are reduced or even eliminated.

If the metal blank is provided with a plastic coating layer, it is preferable for the liquid plastic to be selected to match the plastic coating layer. It has been found that there is then a high likelihood of them fusing together.

Furthermore, it has been found that a plastic coating layer made from polypropylene (PP), modified PP or from polyethylene terephthalate (PET) is eminently suitable for both the coating layer and the plastic for the plastic body.

The liquid plastic may also be provided with a pulverulent filler, such as ceramic particles and/or metallic particles. This allows the properties of the plastic body to be matched to the particular application. For example, ceramic particles can be added in order to improve the wear resistance of the plastic body or to increase the electrically insulating action, or to obtain certain optical properties in the plastic. Metallic particles can be added, for example, in order to obtain certain magnetic and/or electrical properties and/or to obtain certain optical properties in the plastic.

Obviously, these advantages can also be obtained independently of the above-described method by means of a composite product provided with a plastic body which comprises a pulverulent filler.

According to an advantageous embodiment, the metal blank, before it is placed into the die, is provided with means, such as a layer of wax, to ensure that the plastic body only sticks to the blank over part of the blank. As a result, the plastic body will be able to move over the part which is not stuck to the blank. This offers advantageous embodiments of the composite product, as explained in more detail below. As an alternative to a layer of wax, it is also possible, for example, to use a layer of plastic to which the plastic body does not stick, or a metal surface of the metal blank to which the plastic body does not stick.

The invention is also embodied by a device for producing a composite product which comprises a plastic body and a covering layer formed from a metal blank, which covering layer, at least over part of its surface, is stuck to the plastic body, which device comprises a die, which die is provided with a blank holder for the metal blank to be placed and supported in close to its edge, means for closing the die, and a mandrel which can move in relative terms along the blank holder, and means for injecting a liquid plastic into the die, in such a manner that the liquid plastic comes into contact with the metal blank.

The device may be a modified injection-molding device. An injection-molding device usually comprises a mold (die), means for closing the mold and means for injecting a liquid plastic into the mold. The adjustments to an injection-molding device of this type involve the mold being provided with a blank holder for the metal blank to be placed in and supported in the vicinity of its edge, and with a mandrel which can move in relative terms along the blank holder in order to clamp and/or mechanically preform the metal blank. Furthermore, the modified injection-molding device is designed in such a manner that the liquid plastic, when it is being injected into the mold, comes into contact with the metal blank.

Further embodiments of the device according to the invention are dealt with in the dependent claims. The advantages of the measures listed in the claims can be inferred from the above description of the method according to the invention.

The above-described method and/or device can be used to make composite products for use in, for example, (domestic) appliances, in various sectors of industry, such as the white goods industry, the automotive industry, the ship-building industry, in aircraft construction, the space industry, in (consumer) electronics, in housebuilding and in the medical industry.

The product preferably has a metal blank with a thickness of between 0.01 mm and 3.0 mm, more preferably between 0.03 mm and 1.0 mm, and even more preferably between 0.05 mm and 0.5 mm. By using this thickness, it is easy to produce a preformed blank and the composite object will have a metallic appearance on the outer side by using a thin metal blank while only a small amount of metal is required in order to achieve this appearance.

If use is made of the method in which the plastic body is only stuck to the blank over part of the blank, the result is the formation of a plastic element which can move with respect to the blank. This movable element can have various functions, such as a securing element, a resilient element, a click-fit element, a closure element or a pivoting element.

If use is made of the method in which the metal blank is cut under the influence of the pressure with which the liquid plastic is injected into the die, a composite product in which part of the metal blank has been cut out and is connected to the remaining blank by means of a thickened plastic portion is preferably formed.

Possible composite products which can be made using the method described above include a component for a consumer packaging product, such as a cover, cap or closure, an (electronics) housing, a bodywork component, an interior component for the automotive industry, a catering product, or a computer accessory. Composite products which may or may not be encompassed by this list include a hubcap, a housing for external automobile mirror, a housing for an internal automobile mirror, a license plate, a doorknob, an automobile door, an automobile fender, a window frame, dashboard components, a crate, a box, luxury packaging, jewelry packaging, a CD case, a floppy disk casing, a paint can, food packaging, a showerhead, sanitary ware, an electrical wall socket, roof-covering parts, construction components, road signs, a dish for a satellite aerial, a bicycle light, a reflector in automobile lighting, a housing for a mobile telephone, a housing for a computer mouse, a housing for a radio, a housing for a camera, a housing for a calculator, a housing for a remote control, a clock, a watch, a cigarette lighter, a pocket knife, a spectacles case, a spectacles frame, a cap for, for example, a gasoline tank or a pot, pan provided with a plastic coating layer, for example, of Teflon, chips for a casino, for example, luxury beverage packaging, a refrigerator door, washing machine components, refrigerator components, a housing for a microwave, a pencil box, a butter dish, a cable duct, an electrical extension lead plug socket, a housing for lighting, a housing for fluorescent lamps, a cash register, a photo frame, medicine packaging, a desk drawer, a bicycle lock, a stapler, packaging for video tapes, a tool box, chair backs and arms, crockery, a plate, a mug, a dish, a cup, a saucer and cutlery.

These composite products also include the composite products which are provided with a plastic body which comprises a pulverulent filler, as described, inter alia, in the above text.

The invention will now be explained with reference to the drawing, in which:

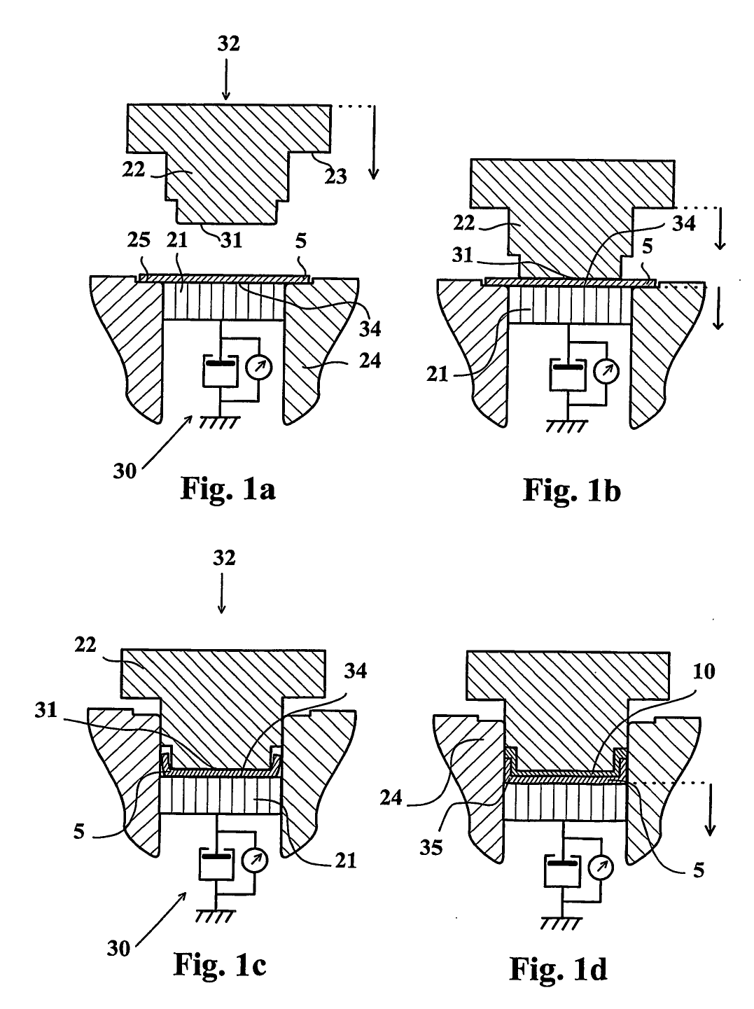

FIG. 1, comprising parts a to d, shows a diagrammatic cross section through an embodiment of the device according to the invention;

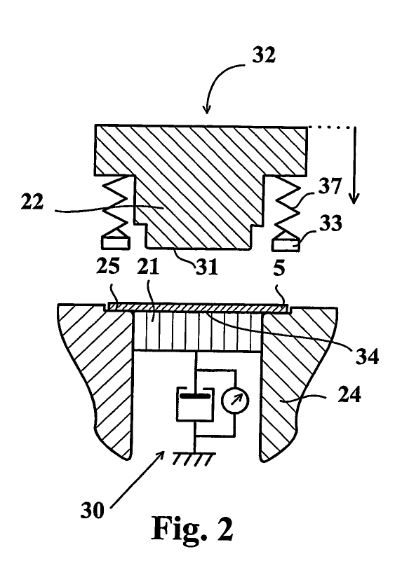

FIG. 2 shows a diagrammatic cross section through another embodiment of the device according to the invention;

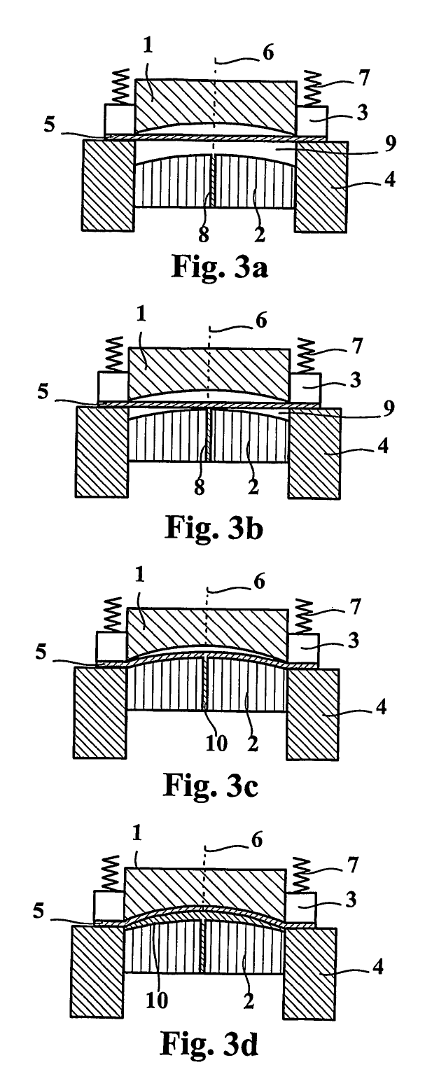

FIG. 3, comprising parts a to d, shows a diagrammatic cross section through another embodiment of the device according to the invention; and

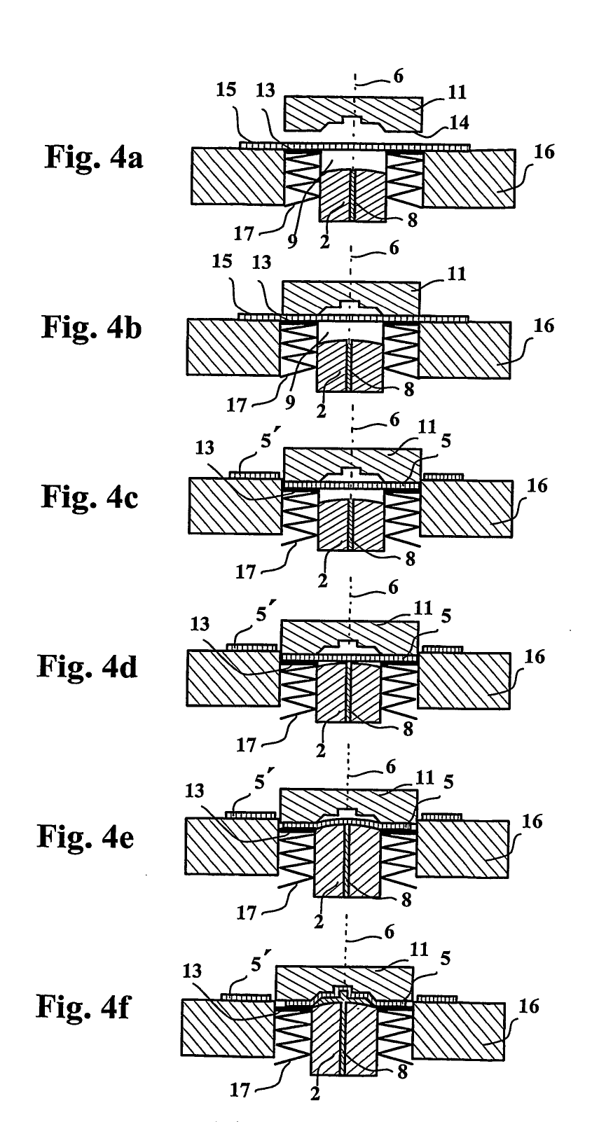

FIG. 4, comprising parts a to f, shows a diagrammatic cross section through yet another embodiment of the device according to the invention.

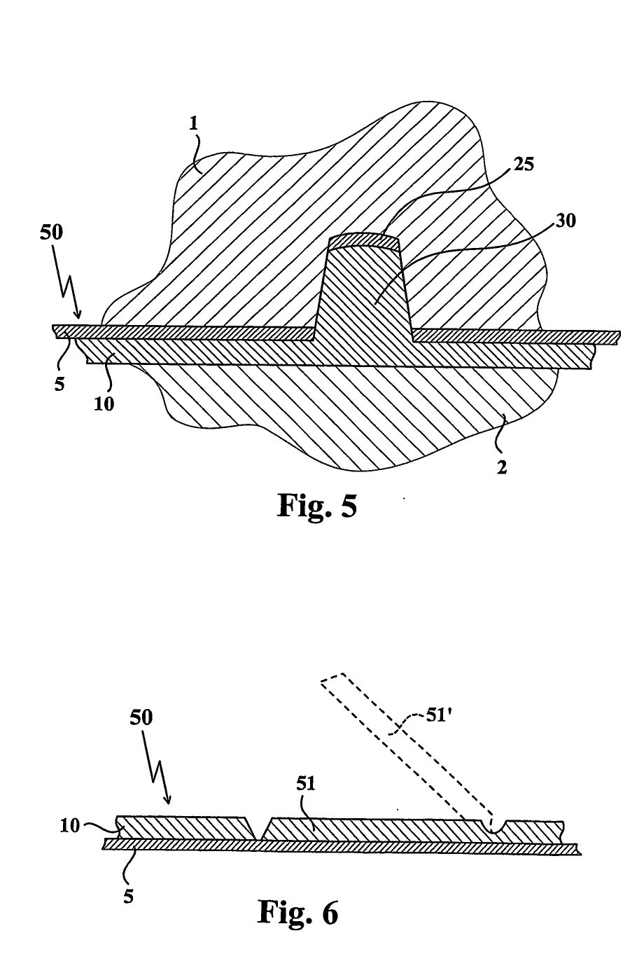

FIG. 5 shows a diagrammatic cross section through a composite product with a cut-out section in accordance with the invention, held inside a die, which is partly illustrated.

FIG. 6 shows a diagrammatic cross section through a composite product having a pivoting section in accordance with the invention.

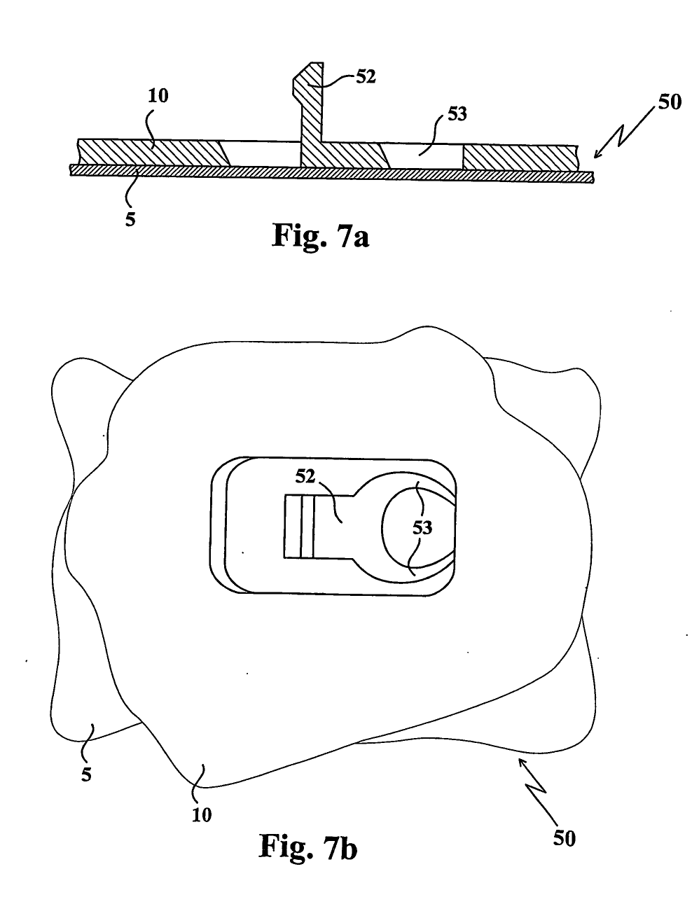

FIG. 7a shows a diagrammatic cross section through another composite product having a pivoting section in accordance with the invention.

FIG. 7b shows a plan view of FIG. 7a

FIG. 1 shows a cross section through a device for producing a composite product comprising a plastic body and a covering layer which is formed from a metal blank and is stuck to the plastic body at least over part of its surface. The device is shown in various successive stages of operation.

FIG. 1a illustrates a blank holder 24 which is substantially cylindrical on the inner side. In the blank holder 24 there is a movable support die 21, which is guided by the cylindrical internal shape of the blank holder. The movable support die 21 is provided with control means 30 for controlling its movement. These control means may comprise a spring. The blank holder 24 is provided with a region 25 which is suitable for a metal blank 5 to be placed on. In addition, there is a mandrel 22, which can be used to mechanically preform the metal blank 5.

In the embodiment shown in FIG. 1, the mandrel 22 forms part of a closure part 32 of the die, which serves to close the die. The closure part is provided with a blank-holder surface 23 which serves to interact with the blank holder 24 when the die is being closed.

The closure of the die is shown in FIG. 1b and FIG. 1c. The mandrel surface 31 of the closure part is brought into contact with the metal blank 5, the metal blank being clamped between the mandrel surface 31 and the support-die surface 34 (cf. FIG 1b). Then, the die is closed further, as shown in FIG. 1c, the support die 21 being moved with the mandrel 22 under the influence of the pressure exerted by the mandrel 22, and the metal blank 5 being preformed as a result.

The clamping pressure which is exerted on the metal blank between the mandrel surface 31 and the support-die surface 34 is controlled by the control means 30.

It should be noted that in the embodiment shown the mandrel 22 has a shape which is such that the metal blank 5, after it has been preformed and, as it were, been draped around the mandrel 22, is enclosed by the mandrel 22 and the blank holder 24.

The device shown in FIG. 1 also has means (not shown) for injecting a liquid plastic 10 into the die, the liquid plastic 10 being brought into contact with a part of the preformed metal blank 5. These means may comprise a bore in the mandrel 22 or the support die 21 or a bore in the blank holder 24. The liquid plastic is then converted into a solid plastic body which is stuck to the preformed metal blank 5.

This can be achieved by injecting the liquid plastic into the die in the form of a molten plastic and then reducing the temperature of the plastic to below the melting point. It is also possible to use a chemically curing plastic which is injected into the cavity 9, if appropriate in combination with a curing agent. In that case, it is possible to inject the liquid plastic into the die at room temperature and then to leave it to cure, for example at elevated temperature.

Before or during the injection of the liquid plastic 10, the support die 21 and the mandrel 22 are moved away from one another. In the case shown in FIG 1d, the support die 21 is moved away from the mandrel 22 during the injection of the liquid plastic 10 under the influence of the pressure of the liquid plastic 10 while it is being injected. Therefore, the preformed metal blank 5 remains supported by the support die 21 during the injection of the liquid plastic 10.

The end edge of the metal blank 5 is also brought into contact with the liquid plastic 10.

The pressure during the injection of the liquid plastic 10 can be selected to be so high that the preformed metal blank 5 is deformed further, as is the case in FIG. 1d at the corners 35, which become sharper under the influence of the pressure of the liquid plastic. The support-die surface 34 and/or the mandrel surface 31, if the liquid plastic is injected between the metal blank 5 and the support die 21, may optionally be of uneven design, so that the metal blank can be shaped further to match the uneven shape.

However, it is also possible for the pressure to be selected to be so low that although the liquid plastic 10 can be made to stick to the preformed metal blank 5, the metal blank 5 is not deformed further.

In addition, there is also the option for the mandrel surface 31 and/or the support-die surface 34 to be of uneven design on that side of the metal blank where the liquid plastic 10 is injected. This results in further shaping of the plastic body.

FIG. 2 shows an alternative embodiment of the device shown in FIG. 1, in which the closure part 32 is provided with sprung means, for example, cup springs 37, and a holding-down clamp surface 33. The section 25 of the blank holder 24 therefore acts as the bottom half of a holding-down clamp. This operates as follows. When the die is being closed, the metal blank 5 is held at its edge in the grip of the holding-down clamp, under the spring force of the cup springs 37, this grip being formed by the section 25 on one side and the holding-down clamp surface 33 on the other side. The grip of the holding-down clamp allows material to flow during the preforming, while in the embodiment shown in FIG. 1 the metal blank is mainly just folded.

FIG. 3a shows a cross section through a device with support die 1 and mandrel 2, which can move relative to one another along axis 6. In this embodiment, the support die is of “fixed” design. The mandrel 2 is provided with a bore 8, which is used for liquid plastic 10 to be injected through. When the device starts to be used, the mandrel is filled with the plastic 10. The device also has holding-down clamp 3, 4 which has a grip which can be closed with the aid of spring 7. A metal blank 5 can be held in the grip of the holding-down clamp 3, 4. In the situation shown in FIG. 3a, a cavity 9 is delimited by the metal blank 5, the mandrel 2 and the bottom half of the holding-down clamp 4.

The device operates in the following way. After the metal blank 5 has been placed in the grip of the holding-down clamp 3, 4 and the grip has been held closed with the aid of the spring 7, the mandrel 2 is moved in relative motion toward the support die 1. FIG. 3b shows the situation where contact has formed between the metal blank 5 and the mandrel 2.

Then the metal blank 5 is mechanically deep-drawn, the metal blank 5 being partly pulled out of the grip of the holding-down clamp 3, 4, during which process the metal blank 5 undergoes a certain resistance as a result of the spring force.

FIG. 3c shows that, following the mechanical deep-drawing, the plastic 10 is injected into the cavity 9 in liquid form, the metal blank 5 being changed further into the desired shape under the influence of the pressure. FIG. 3d shows the situation in which the entire cavity has been filled with the plastic 10 and the metal blank 5 has been pressed onto the support die 1.

In the situation shown in FIG. 3d, the liquid plastic is solidified before the mandrel 2 is retracted. This can be achieved by reducing the temperature of the plastic to below its melting point. It is also possible to use a chemically curing plastic, which is injected into the cavity 9, if appropriate in combination with a curing agent.

FIG. 4a shows, in cross section, another device with support die 11 and mandrel 2, which can move relative to one another along axis 6. The mandrel 2 is provided with a bore 8, which is used for a liquid plastic 10 to be injected through. At the start of the use of the device, the mandrel is filled with the plastic 10, the device also comprises a cutting frame 16.

In the embodiment shown in FIG. 4, the support die 11 also acts as the blank holder comprising the holding-down clamp. The grip of the holding-down clamp is formed by the flat part 14 of support die 11, on the one hand, and holding-down clamp surface 13, on the other hand. Holding-down clamp surface 13 can be held against the flat part 14 under spring force with the aid of cup springs 17.

In the situation of the device shown in FIG. 4a, a metal starting blank 15 has been placed into the device. FIG. 4b shows the situation in which support die 11 has just been placed against the metal starting blank 15 as a result of relative movement of the support die 11, along axis 6. The metal starting blank 15 projects beyond the grip of the holding-down clamp 13, 14. As a result of support die 11 being moved further along axis 6, the metal starting blank 15 is brought under spring force into the grip of the holding-down clamp 13, 14 and at the same time the metal starting blank 15 is cut into the desired shape having the correct cross section. The cutting of the metal starting blank 15 is effected as a result of support die 11 being moved into the cutting frame 16. This results in the formation of a metal blank 5 which has been cut to size and a remaining piece 5′. This is shown in FIGS. 4c and d.

As a result of the cup springs 17 being compressed over a desired length, the desired spring force is achieved, as illustrated in FIG. 4d.

In FIG. 4e, the mandrel 2 has been moved in relative motion along axis 6 towards the support die. As a result, the metal blank 5 has been mechanically deep-drawn, the metal blank 5 being pulled partially out of the grip of the holding-down clamp 13, 14, the metal blank 5 in the process being subject to a certain resistance as a result of the spring force.

Then, the plastic 10 is injected into the cavity 9 in liquid form, with the metal blank 5 being moved further into the desired shape under the influence of the pressure. In the process, as shown in FIG. 4f, the entire cavity is filled with the plastic 10 and the metal blank 5 is pressed onto the support die 11. In this way, a fine relief can be applied to the metal covering layer.

Obviously, the liquid plastic is solidified before the mandrel 2 is retracted. This can be achieved by reducing the temperature of the plastic to below its melting point. It is also possible to use a chemically curing plastic which is injected into the cavity 9, if appropriate, in combination with a curing agent.

In the embodiments which have been illustrated with reference to FIG. 3 and FIG. 4, a section of the metal blank 5 remains in the grip of the holding-down clamp during the injection of the plastic 10. Therefore, the product continues to have a flange. However, the metal blank 5 may also be selected in such a manner that the metal blank is drawn entirely inside the grip of the holding-down clamp. It is then possible to continue with the injection of the plastic 10, so that pleasing finishing of the end edge of the metal covering layer is achieved.

The following table gives an overview of process parameters which can be used in the case of injection of PP or PET. Tests were carried out using an injected plastic volume of 8 cm³, and a metal blank formed from packing steel (T57 temper) with a thickness of 0.21 mm and coated with a layer of PP with a thickness of approximately 20 μm or with a layer of PET with a thickness of approximately 20 μm.

| Parameter | Plastic: PP | Plastic: PET |
|---|---|---|
| Injection pressure | 800 bar | 1200, 1250, 1350 bar |
| Liquid plastic flow rate | 10.0 cm³/s | 10, 15, 20, 25 cm³/s |
| Injection temperature | 180-220° C. | 250-270° C. |
| Die cooling temperature | 60, 65, 70° C. | 50° C. |

The result is composite products with very good bonding between the plastic body and the metal covering layer.

It has been found that the higher the injection pressure and/or the liquid plastic flow rate is/are selected to be, the tauter and smoother the bonding of the plastic body to the metal blank has proven to be. Therefore, it is possible to apply a thinner plastic body if desired.

The choice of the injection temperature in combination with the cooling temperature of the die results in optimum fusing of the plastic to the coating layer and therefore good bonding between the metal covering layer and the plastic body.

The person skilled in the art will be able to match the abovementioned parameters to the conditions relating to the type of product which it is intended to produce and to the rheological properties of the plastic used.

The device as shown may be modified plastics injected-molding devices, in which the die (mold) is provided with the blank holder for the metal blank to be placed and supported in close to its edge, and in which there is a mandrel which can move in relative terms along the blank holder in order to mechanically preform the metal blank

FIG. 5 diagrammatically depicts a cross section through a composite product 50, which is partially illustrated and comprises a metal blank 5, optionally preformed, a plastic body 10, and a cut-out section 25 of the blank. The cut-out section 25 is connected to the remaining section of the blank and the product by means of the elevation 30 in the plastic body. The composite product 50 has been formed in a die, of which a section of the mandrel 2 and the support die 1 are illustrated. The support die 1 has a recessed section with a cutting edge, with the result that the section 25 of the metal blank 5 is cut off under the pressure exerted by the liquid plastic along the cutting edge along the recessed section in the support die. The liquid plastic then presses the cut-out section 25 onto the bottom of the recessed section and fills this section with plastic, resulting in the formation of the elevation 30.

FIG. 6 diagrammatically depicts a cross section through a composite product 50 comprising a metal blank 5 and a plastic body 10, in which the plastic body 10 is not stuck to the metal blank 5 over a part 51, for example as a result of a layer of wax being positioned at this location before the plastic is applied. Since the part 51 is not stuck to the metal blank 5, this part 51 can pivot with respect to those parts of the plastic body and metal blank which are stuck together, cf. the part 51′ which is indicated by dashed lines.

FIG. 7a diagrammatically depicts another example of a part 52 of a plastic body 10 which is not stuck to the metal blank and is connected by means of arms 53 to that part of the plastic body 5 which is stuck to the metal blank 5, which plastic body, together with the metal blank 5, forms a section of a composite product 50. The pivoting part 52 and the arms 53 are not stuck to the metal blank, for example as a result of a layer of wax being applied before the plastic is applied. On account of the flexibility of the plastic arms 53, cf. the plan view shown in FIG. 7, the pivoting part 52 can move to and fro over the surface of the metal blank, to the left and right in the figure, with the arms 53 serving as guides.

Therefore, with the aid of parts of the plastic body which are not stuck to the blank, as shown in FIGS. 6 and 7, the composite product according to the invention can be provided with a movable element, such as a securing element, a resilient element, a click-fit element, a closure element or a pivoting element.

The devices and products shown serve to clarify the invention. It will be understood that the invention is not restricted to only the embodiments which are illustrated, and in any event, different combinations between the embodiments shown must also be considered to have been described.

1. A method for producing a composite product comprising a plastic body and a covering layer formed from a metal blank which at least over part of its surface is stuck to the plastic body, comprising
placing the metal blank in a die, the die comprises a blank holder, a mandrel movable with respect to the blank holder, and a support die,
closing the die, so that the support die and the mandrel are located on either side of the metal blank, and the metal blank is supported in the vicinity of its edge with the aid of the blank holder,
injecting a liquid plastic into the die, the liquid plastic being brought into contact with the metal blank,
converting the liquid plastic into a solid plastic body which is stuck to the metal blank to produce the composite product,
removing the composite product from the die.

2. The method as claimed in claim 1, wherein the metal blank is supported in the blank holder in the vicinity of its edge, and the metal blank, after the die has been closed and before the liquid plastic is injected, is mechanically preformed with the aid of the mandrel, the mandrel being moved in relative motion along the blank holder toward the support die.

3. The method as claimed in claim 1, wherein the liquid plastic is injected into the die under pressure, the entire available space being filled with the liquid plastic.

4. The method as claimed in claim 3, wherein the pressure is at least 200 bar and at most 4000 bar.

5. The method as claimed in claim 1, wherein the liquid plastic is injected into the die at a liquid plastic flow rate of at least 10 cm³/s.

6. The method as claimed in claim 1, wherein during preforming of the metal blank, the metal blank is clamped between the mandrel and the support die, and the support die is moved together with the mandrel.

7. The method as claimed in claim 1, wherein the mandrel and the support die are moved apart before or during the injection of the liquid plastic.

8. The method as claimed in claim 1, wherein during the injection of the liquid plastic the latter is also brought into contact with an end edge of the metal blank which is preformed.

9. The method as claimed in claim 1, wherein the metal blank, at least during preforming, is held in a grip, which is closed by spring force, of a holding-down clamp which is present in the blank holder.

10. The method as claimed in claim 1, wherein the metal blank, at least during the injection of the liquid plastic, is held in a grip, which is closed by spring force, of the holding-down clamp.

11. The method as claimed in claim 9, wherein the spring force is selected to be such that the metal blank is pulled out of the grip of the holding-down clamp and in the process is subject to a certain resistance.

12. The method as claimed in claim 1, wherein, after the liquid plastic has been injected into the die, additional material is injected into the die in at least one after-molding step.

13. The method as claimed in claim 1, wherein the metal blank is selected from a group of types of metal consisting of steel, stainless steel, galvanized steel, tin-plated steel, chrome-plated steel, copper-plated steel, Ni-coated steel, aluminum, and alloys based on a member selected from the group consisting of aluminum, copper, zinc, nickel, brass, bronze, silver, gold, and titanium.

14. The method as claimed in claim 1, wherein the plastic is selected from a group of types of plastic consisting of PP, PET, PE, ABS, PMMA, SAN, PC, PA, PU, PUR, SAN and copolymers thereof, optionally filled with a pulverulent filler, or optionally filled with foaming agents.

15. The method as claimed in claim 1, wherein the metal blank is provided with a plastic coating layer.

16. The method as claimed in claim 1, wherein the liquid plastic is injected into the die under pressure and the metal blank is cut under the influence of the pressure with which the liquid plastic is forced into the die.

17. The method as claimed in claim 1, wherein the metal blank, before the metal blank is placed into the die, is provided with means, to ensure that the plastic body can only stick to the blank over part of the blank.

18. A device for producing a composite product which comprises a plastic body and a covering layer formed from a metal blank, the covering layer, at least over part of its surface, is stuck to the plastic body,
the device comprises a die, the die is provided with a blank holder for the metal blank to be placed and supported in close to its edge, means for closing the die, a support die and a mandrel movable in relative terms along the blank holder toward the support die, and means for injecting a liquid plastic into the die, in such a manner that the liquid plastic comes into contact with the metal blank.

19. The device as claimed in claim 18, wherein the device comprises means for melting the plastic before injecting the plastic in liquid form into the die, and means for solidifying the liquid plastic in contact with the metal blank.

20. The device as claimed in claim 18, wherein the support die is movable with the mandrel, and the metal blank is clampable between the support die and the mandrel.

21. The device as claimed in claim 18, wherein the support die and the mandrel, during operating of the means for injecting the plastic into the die, are movable away from one another.

22. The device as claimed in claim 18, wherein the blank holder comprises a holding-down clamp which has a grip closable by spring force to hold the metal blank.

23. The device as claimed in claim 18, wherein the mandrel is provided with an uneven mandrel surface to interact with the composite product to produce a defined shape on the composite product.

24. The device as claimed in claim 18 for carrying out a method for producing a composite product comprising a plastic body and a covering layer formed from a metal blank which at least over part of its surface is stuck to the plastic body, wherein
placing the metal blank in a die, which die comprises a blank holder, a mandrel movable with respect to the blank holder, and a support die,
closing the die, so that the support die and the mandrel are located on either side of the metal blank, and the metal blank is supported in the vicinity of its edge with the aid of the blank holder,
injecting a liquid plastic into the die, the liquid plastic being brought into contact with the metal blank,
converting the liquid plastic into a solid plastic body which is stuck to the metal blank to produce the composite product,
removing the composite product from the die, wherein the liquid plastic is injected into the die under pressure and the metal blank is cut under the influence of the pressure with which the liquid plastic is forced into the die, wherein the support die is provided with a recessed section with a cutting edge.

25. A composite product produced with the aid of the method as claimed in claim 1, wherein the blank has a thickness of between 0.01 mm and 3.0 mm.

26. A composite product produced with the aid of the method as claimed in claim 17, wherein the plastic body is only stuck to the metal blank over part of the blank, to form an element which is movable with respect to the blank.

27. A composite product produced with the aid of the method as claimed in claim 16, wherein a section of the metal blank is cut out and is connected to the remainder of the blank by a thickened plastic portion.

28. The composite product as claimed in claim 27, wherein the product is a component for a consumer packaging product.

29. The method as claimed in claim 1, wherein the liquid plastic is injected into the die under pressure, during which process the metal blank is shaped.

30. The method as claimed in claim 1, wherein the liquid plastic is injected into the die at a liquid plastic flow rate of at least 20 cm³/s.

31. The method as claimed in claim 1, wherein the plastic is selected from a group of types of plastic consisting of PP, PET, PE, ABS, PMMA, SAN, PC, PA, PU, PUR, SAN and copolymers thereof, optionally filled with a pulverulent filler, selected from the group consisting of ceramic and/or metallic particles, or optionally filled with foaming agents.

32. The method as claimed in claim 1, wherein the metal blank is provided with a plastic coating layer fused to the injected plastic

33. The method as claimed in claim 1, wherein the metal blank is provided with a plastic coating layer fused to the injected plastic selected from the group consisting of PET, PP and holographic material.

34. The method as claimed in claim 1, wherein the metal blank, before the metal blank is placed into the die, is provided with a layer of wax to ensure that the plastic body can only stick to the blank over part of the blank.

35. The device as claimed in claim 18, wherein the support die is provided with an uneven support-die surface to interact with the composite product to produce a defined shape on the composite product.

36. A composite product produced with the aid of the method as claimed in claim 17, wherein the plastic body is only stuck to the metal blank over part of the blank, to form an element movable with respect to the blank, the element selected from the group consisting of a securing element, a resilient element, a click-fit element, a closure element and a pivoting element.

37. The composite product as claimed in claim 27, wherein the product is a component for a consumer packaging product selected from the group consisting of a cover, cap or closure, an (electronics) housing, a bodywork component, an interior component for the automotive industry, a catering product, and a computer accessory.

38. The method as claimed in claim 1, wherein the metal blank the liquid plastic contacts is a preformed metal blank, wherein a cavity has been formed in the preformed metal blank, and during the injection of the liquid plastic the cavity formed in the preformed metal blank is partly filled with the mandrel.

39. The method as claimed in claim 1, wherein the metal blank is a non-preformed metal blank to which the layer of plastic is applied in the form of a recess in the mandrel.

40. The method as claimed in claim 1, wherein the liquid plastic is injected into the die, the liquid plastic being brought into contact with the metal blank which has been preformed.
